(19) United States
(12) Patent Application Publication
(10) Pub. No.: US 2016/0165966 A1
(43) Pub. Date: Jun. 16, 2016

(54) Article of Clothing and Method of Displaying a Pattern on Clothing

(71) Applicant: GOLDEN VAST MACAO COMMERCIAL OFFSHORE LIMITED, Macau (CN)

(72) Inventor: KwokFong WONG, HongKong (CN)

(21) Appl. No.: 14/959,212

(22) Filed: Dec. 4, 2015

(30) Foreign Application Priority Data
Dec. 10, 2014 (CN) 201410758960.4

(51) Int. Cl. A41D 1/00; G06T 11/20; G09G 3/20; A41D 27/08

(52) U.S. Cl. CPC A41D 1/002; A41D 27/08; G06T 11/20; G09G 3/2092; G09G 2370/16; G09G 2380/02; G09G 2310/08

(57) ABSTRACT

The invention discloses clothing that can display a pattern and a display method. Such clothing may include, for example, a clothing main body, a controller, a communication unit and a power source which are disposed on the clothing main body. The communication unit is used for receiving a pattern sent by an external device. The controller is used for receiving an instruction from a user and controlling the display of the pattern on the clothing main body according to the instruction. The power source is used for supplying power for the clothing main body and/or the controller and/or the communication unit. The clothing main body may be made of a material which can display a pattern, thus the clothing main body itself is used as a display device to display different patterns obtained from the external device and displayed changeably on the clothing main body.

### FIELD OF THE INVENTION

The present invention relates to the field of display, and more particularly to an article of clothing that can change the display of a pattern and a display method based on the clothing

### DESCRIPTION OF THE RELATED ART

A pattern on the existing clothing is made in the course of the production of cloth, or is embroidered subsequently. However, whatever method is used, the pattern on the clothing can not be changed after being formed. If a user desires any other patterns, he/she has to buy new clothes.

### SUMMARY OF THE INVENTION

In order to solve the above problem of the prior art, the invention provides clothing that can display a pattern, the clothing comprises a clothing main body which can display a pattern, a controller, a communication unit and a power source. The controller, the communication unit and the power source are disposed on the clothing main body.

The communication unit is used for receiving a pattern sent by an external device.

The controller is used for receiving an instruction from a user, and controlling the display of the pattern on the clothing main body according to the instruction.

The clothing main body is made of a material which can display a pattern.

The power source is used for supplying power for the clothing main body and/or the controller and/or the communication unit.

Preferably, the clothing main body is consisted of a plurality of display chips electrically connected with each other.

Preferably, the power source is a solar energy power source, and/or the communication unit is a near field communication unit or a bluetooth communication unit.

Preferably, the controller specifically is used for receiving an instruction of changing pattern display from the user, and changing the pattern displayed on the clothing main body according to the instruction of changing pattern display.

Preferably, the clothing further comprises a timer disposed on the clothing main body.

The controller is connected to the timer, for receiving an instruction of periodical display input by a user, and controlling the periodical display of different patterns on the clothing main body according to the instruction of periodical display and the timing results of the timer.

In another aspect, the invention also provides a display method of a pattern, for use in the above clothing, comprises the following steps:
receiving a pattern sent by an external device; and
receiving an instruction from a user, and controlling the display of the pattern on

the clothing main body according to the instruction.

The clothing main body is made of a material which can display a pattern.

Preferably, the clothing main body is consisted of a plurality of display chips electrically connected with each other.

Preferably, the power source is a solar energy power source, and/or the communication unit is a near field communication unit or a bluetooth communication unit.

Preferably, receiving an instruction from a user and controlling the display of the pattern on the clothing main body according to the instruction comprises:
receiving an instruction of changing pattern display from the user, and changing the pattern displayed on the clothing main body.

Preferably, the clothing further comprises a timer disposed on the clothing main body and connected with the controller.

Preferably, receiving an instruction from a user, and controlling the display of the pattern on the clothing main body according to the instruction comprises receiving an instruction of periodical display input by a user, and controlling the period display of different patterns on the clothing main body according to the instruction displayed periodically and timing results of the timer.

Due to the application of the above technical solutions, the invention has the following advantages:

the clothing main body of the invention is made of a material which can display a pattern, thus the clothing main body itself also can be used as a display device, in combination with the communication unit, the controller and the like, different patterns can be obtained from the external device, and can be displayed changeably on the clothing main body as desired.

### BRIEF DESCRIPTION OF THE DRAWINGS

In order to illustrate the technical solutions of the embodiments of the invention more clearly, the drawings used in the detailed description will be simply described hereinafter. Obviously, these drawings only represent some embodiments by way of example, and for one skilled in the art, other drawings can be obtained in terms of these drawings without any creative work.

FIG. 1 is a schematic view of the clothing that can display a pattern according to embodiment 1 of the invention;

FIG. 2 is flow chart of the method according to embodiment 2 of the invention.

### DESCRIPTION OF THE PREFERRED EMBODIMENTS

For making the object, technical solutions and advantages of the invention more clearly, the preferred embodiments of present invention will be described hereinafter in more detail with reference to the accompanying drawings.

The invention is intended to provide clothing that can display a pattern and a display method based on it, so that a clothing main body can be used as a display device and different patterns can be displayed on the clothing main body according to the intentions of a user.

### Embodiment 1

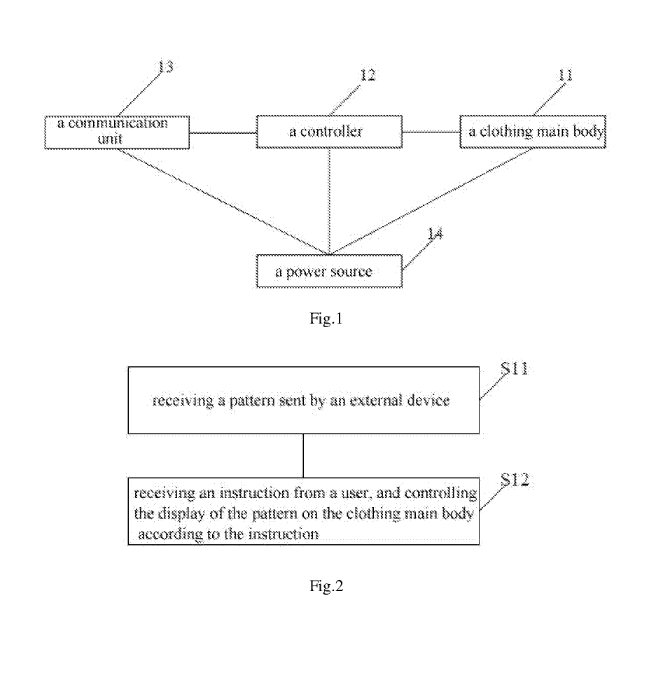

As shown in FIG. 1, the clothing that can display a pattern comprises:

a clothing main body 11 which can display a pattern, a controller 12, a communication unit 13 and a power source 14, wherein the controller 12, the communication unit 13 and the power source 14 are disposed on the clothing main body 11.

The communication unit 13 is used for receiving a pattern sent by an external device, and specifically can receive a pattern downloaded from the internet by a mobile terminal. The communication unit 13 may be a near field communication unit, or a bluetooth communication unit, or other communication units, and this is not limited in the invention.

The controller 12 is used for receiving an instruction from a user, and controlling the display of the pattern on the clothing main body 11 according to the instruction.

It should be noted that, the clothing main body of the invention can be made of a material which can display a pattern, based on this, the clothing main body itself can be used as a display device. In the invention, the clothing main body may be consisted of a plurality of display chips electrically connected with each other. In a preferable embodiment, the material of which the clothing main body is made is selected as a flexible material, so that it is suitable for the human body to wear.

The above power source 14 is used for supplying power for at least one of the said clothing main body 11, the controller 12 and the communication unit 13.

The power source 14 may be a battery, or the solar energy can be used to supply power and the solar energy is converted to a power source, and this is not limited in the invention.

The above controller 12 is specifically used for controlling the display of a pattern on the clothing main body according to a display instruction, close instruction etc. input by a user. For example, when a close instruction is received, the controller 12 controls the clothing main body not to display any pattern. When a display instruction is received, the controller 12 controls the clothing main body 11 to display a pattern selected by a user.

In the invention, the clothing body 11 can change the pattern displayed thereon according to the intentions of the user. That is to say, the controller 12 receives an instruction of changing pattern display from a user and changes the pattern displayed on the clothing main body according to the instruction of changing pattern display.

In the invention, the controller 12 can store multiple patterns therein for displaying on the clothing main body 11. For saving the storage space, in the invention the controller 12 can control the communication unit 13 to obtain the corresponding pattern from an external device, after a new display instruction is input by a user.

In addition, in the invention, the clothing main body 11 also can periodically display several selected patterns. Thus, in the invention, the clothing further comprises a timer. The controller is connected to the timer for receiving an instruction of periodical display input by a user and controlling the period display of different patterns on the clothing main body according to the instruction of periodical display and timing results of the timer.

For example, if each selected pattern is set to display for 1 minute and then another pattern is displayed, then the controller will control the clothing main body to periodically display the selected patterns according to the set order.

Certainly, other ways of pattern display also are contained in the invention, and this is not limited in the invention.

### Embodiment 2

Corresponding to the above clothing that can display a pattern, the invention also provides a display method of a pattern, for use in the above clothing As shown in FIG. 2, the method comprises the following steps:
S11, receiving a pattern sent by an external device; specifically, a pattern downloaded from the internet by a mobile terminal can be received. In the invention, the communication unit 13 may be a near field communication unit, or a bluetooth communication unit, or other communication units, and this is not limited by the invention.
S12, receiving an instruction from a user, and controlling the display of the pattern on the clothing main body according to the instruction. It is noted that, the clothing main body may be made of a material that can display a pattern, based on this, the clothing main body itself may be used as a big display device. In the invention, the clothing main body is consisted of a plurality of display chips electrically connected with each other. In a preferable embodiment, the material of the clothing main body may be selected from flexible materials, so that it is suitable for the human body to wear.

The above step S12 is specifically used for controlling the display of pattern on the clothing main body according to the display instruction, close instruction and the like input by a user. For example, when a close instruction is received, the clothing main body is controlled not to display any pattern. When a display instruction is received, clothing main body is controlled to display a pattern selected by a user.

In the invention, the clothing main body 11 can change the patterns displayed thereon according to the intentions of the user. That is to say, an instruction of changing pattern display from a user is received and the pattern displayed on the clothing main body is changed according to the instruction of changing pattern display.

In the invention, multiple patterns may be stored in the controller, for displaying on the clothing main body. For saving the storage space, in the invention the controller can control the communication unit to obtain the corresponding pattern from an external device, after a new display instruction is input by the user.

In addition, in the invention, the clothing main body also can periodically display several selected patterns. Thus, in the invention, the clothing further comprise a timer disposed on the clothing main body and connected with the controller, the above step S12 specifically is receiving an instruction of periodical display input by a user and controlling the period display of different patterns on the clothing main body according to the instruction of periodical display and timing results of the timer.

For example, if each selected pattern is set to display for 1 minute and then another pattern is displayed, then the controller will control the clothing main body to periodically display the selected patterns according to the set order.

The clothing main body of the invention can be made of a material which can display a pattern, and thus the clothing main body itself may be used as a display device, in combination with the communication unit and controller and the like, different patterns can be obtained from the external device, and can be changeably displayed on the clothing main body as desired.

The above method is corresponding to the clothing that can display a pattern, and the associated features can be referred to each other, and any more details will not be described in the invention.

A person skilled in the art shall appreciate that, part or all of the steps achieving the above embodiments can be completed by means of hardware, or by instructing related hardware via a program, the program may be stored in a computer-readable storage medium which may be a read only memory, magnetic disk or optical disc or the like.

The preferred embodiments are described as above by way of example in the invention, and shall not be considered as limitation of the invention. Any amendments, equivalent replacements and improvements made within the spirit and principle of the invention shall be covered in the protection scope of the invention.

1. Clothing that can display a pattern, comprising a clothing main body which can display a pattern, and a controller, a communication unit and a power source which are disposed on the clothing main body,
wherein the communication unit is used for receiving a pattern sent by an external device;
the controller being used for receiving an instruction from a user, and controlling the display of the pattern on the clothing main body according to the instruction;
the clothing main body being made of a material which can display a pattern;
the power source being used for supplying power for the clothing main body and/or the controller and/or the communication unit.

2. The clothing that can display a pattern as claimed in claim 1, wherein the clothing main body is consisted of a plurality of display chips electrically connected with each other.

3. The clothing that can display a pattern as claimed in claim 1, wherein the power source is a solar energy power source, and/or the communication unit is a near field communication unit or a bluetooth communication unit.

4. The clothing that can display a pattern as claimed in claim 1, wherein the controller specifically is used for receiving an instruction of changing pattern display from the user, and changing the pattern displayed on the clothing main body according to the instruction of changing pattern display.

5. The clothing that can display a pattern as claimed in claim 1, wherein the clothing further comprises a timer disposed on the clothing main body;
the controller being connected with the timer, for receiving an instruction of periodical display input by the user, and controlling the periodical display of different patterns on the clothing main body according to the instruction of periodical display and the timing results of the timer.

6. A display method of a pattern, for use in the clothing of the claim 1, comprising:
receiving a pattern sent by an external device;
receiving an instruction from a user, and controlling the display of the pattern on the clothing main body according to the instruction;
wherein the clothing main body is made of a material which can display a pattern.

7. The method as claimed in claim 6, wherein the clothing main body is consisted of a plurality of display chips electrically connected with each other.

8. The method as claimed in claim 6, wherein the power source is a solar energy power source, and/or the communication unit is a near field communication unit or a bluetooth communication unit.

9. The method as claimed in claim 6, wherein the receiving an instruction from a user, and controlling the display of the pattern on the clothing main body according to the instruction comprises:
receiving an instruction of changing pattern display from the user, and changing the pattern displayed on the clothing main body.

10. The method as claimed in claim 6, wherein the clothing further comprises a timer disposed on the clothing main body and connected with the controller;
the receiving an instruction from a user, and controlling the display of the pattern on the clothing main body according to the instruction comprises receiving an instruction of periodical display input by a user, and controlling the period display of different patterns on the clothing main body according to the instruction displayed periodically and timing results of the timer.

11. The clothing that can display a pattern as claimed in claim 2, wherein the power source is a solar energy power source, and/or the communication unit is a near field communication unit or a bluetooth communication unit.

12. The clothing that can display a pattern as claimed in claim 2, wherein the controller specifically is used for receiving an instruction of changing pattern display from the user, and changing the pattern displayed on the clothing main body according to the instruction of changing pattern display.

13. The clothing that can display a pattern as claimed in claim 2, wherein the clothing further comprises a timer disposed on the clothing main body;
the controller being connected with the timer, for receiving an instruction of periodical display input by the user, and controlling the periodical display of different patterns on the clothing main body according to the instruction of periodical display and the timing results of the timer.

14. The method as claimed in claim 7, wherein the power source is a solar energy power source, and/or the communication unit is a near field communication unit or a bluetooth communication unit.

15. The method as claimed in claim 7, wherein the receiving an instruction from a user, and controlling the display of the pattern on the clothing main body according to the instruction comprises:
receiving an instruction of changing pattern display from the user, and changing the pattern displayed on the clothing main body.

16. The method as claimed in claim 7, wherein the clothing further comprises a timer disposed on the clothing main body and connected with the controller;
the receiving an instruction from a user, and controlling the display of the pattern on the clothing main body according to the instruction comprises receiving an instruction of periodical display input by a user, and controlling the period display of different patterns on the clothing main body according to the instruction displayed periodically and timing results of the timer.
